(19) United States
(12) Patent Application Publication
(10) Pub. No.: US 2023/0004360 A1
(43) Pub. Date: Jan. 5, 2023

(54) METHODS FOR MANAGING PROCESS APPLICATION DEVELOPMENT AND INTEGRATION WITH BOTS AND DEVICES THEREOF

(71) Applicant: Kore.ai, Inc., Orlando, FL (US)

(72) Inventors: Rajkumar Koneru, Windermere, FL (US); Prasanna Kumar Arikala Gunalan, Hyderabad (IN)

(21) Appl. No.: 17/364,267

(22) Filed: Jun. 30, 2021

(51) Int. Cl. G06F 8/30; G06N 20/00

(52) U.S. Cl. CPC G06F 8/30; G06N 20/00

(57) ABSTRACT

An integrated design and development platform (IDDP) server receives instructions corresponding to one or more user interactions in a graphical user interface rendered in a user device such as an I/O device or an external computing device. The IDDP server enables, based on the received one or more instructions, conversational interaction with a process application by cloning one or more bot definitions and adding the cloned one or more bot definitions to an existing bot or a new bot and by automatically configuring the cloned one or more bot definitions to at least communicate with the process application.

### FIELD

This technology generally relates to methods, devices, and non-transitory computer readable media for managing process application development and integration with bots.

### BACKGROUND

Day-to-day activities in many businesses include repetitive tasks such as employee onboarding, leave approvals, raising tickets, application access requests, or the like. Often such repetitive tasks are managed by paper files, spreadsheets, and/or online documents, in channels, such as messengers or email. Managing these repetitive tasks using such methods is time consuming, requires significant human effort, and is error prone.

Process management software (PMS) limits these types of problems by automating such tasks using process applications or workflows. Some PMS requires specialized knowledge to create, code and configure the process applications. Other PMS offers drag and drop interfaces, trigger-based execution, Application programming interface (API) integration, and analytics to build and manage process applications. This reduces the time to create the process applications and improve the ease of use. However, the existing PMS are rule-based and lack intelligence.

Virtual assistants or bots are increasingly being deployed across all businesses and are used to conversationally assist their workforce and customers. However, the integration of bots with process applications and PMS is still in its nascent stages. In one example, a bot can pass certain parameters to a process application. Also, bot development and process application development require different skill sets and may not be accomplished by the same development team. Often one development team works on developing the process applications and another development team works on developing the bots. These development teams communicate with each other to facilitate integration. Hence, creating process applications becomes a nuanced and time-consuming task, especially when the process applications need to be integrated with bots. In this low-code/no-code era, there is a need to overcome this difficulty and enable novice users to create and integrate applications with bots with minimum effort. Hence, there is a need to provide improved process application development by enabling other bots and other applications to integrate with PMS quickly and efficiently.

### SUMMARY

An example method comprises receiving, by an integrated design and development platform (IDDP) server, instructions corresponding to one or more user interactions in a graphical user interface rendered in a user device. The IDDP server enables conversational interaction with a process application based on the instructions by cloning one or more bot definitions and adding the cloned one or more bot definitions to an existing bot or a new bot. The cloned one or more bot definitions are automatically configured to communicate with the process application.

In an example, an integrated design and development platform (IDDP) server comprises a processor, a memory coupled to the processor which is configured to be capable of executing programmed instructions stored in the memory to receive instructions corresponding to one or more user interactions performed in a graphical user interface rendered in a user device. Enable, based on the received instructions, conversational interaction with a process application by adding a clone of one or more bot definitions to an existing bot or a new bot and automatically configuring the cloned one or more bot definitions to interact with the process application.

In an example, a non-transitory computer readable storage medium having stored thereon instructions, for generating a response, which when executed by a processor, causes the processor to receive instructions corresponding to one or more user interactions performed in a graphical user interface rendered in a user device. Based on the received instructions, enable conversational interaction with a process application by adding a clone of one or more bot definitions in an existing bot or a new bot and automatically configuring the cloned one or more bot definitions to interact with the process application.

### BRIEF DESCRIPTION OF THE DRAWINGS

FIG. 1 is a block diagram of an exemplary environment with an example of an integrated design and development server configurable to execute an integrated design and development platform.

FIG. 2 is a block diagram of a cloud computing environment which can be used to implement the integrated design and development platform.

FIG. 3 is a block diagram of an example of components of the integrated design and development platform shown in FIG. 1.

FIG. 4 is a flowchart of an example of a method to auto create bot tasks which enable conversational interaction with a process application.

FIG. 5A is a partial flowchart and partial screenshot of an exemplary transition of a display state of an integrated development environment corresponding to the process application.

FIG. 5B is a partial flowchart and partial screenshot of an exemplary configuration of the auto created get status bot task as displayed in the integrated development environment.

FIG. 5C is a partial screenshot of a third selection in the process application in the integrated development environment.

FIG. 5D is a flowchart of an example of a get status bot task created based on the third selection in the integrated development environment.

FIG. 5E is a partial flowchart and partial screenshot of an exemplary configuration of the auto created get status bot task as displayed in the integrated development environment.

FIG. 6 is a flowchart of an example of a method to execute an auto-created get status bot task.

FIG. 7 is a listing of code for an example GET call configuration to the get-status-API end point.

FIG. 8 is a flowchart of an example of a method of executing an auto-created get details bot task.

FIG. 9 is a flowchart of an example of a method to assign one or more process inputs corresponding to one or more triggers to a single process variable corresponding to the process application in the integrated development environment.

FIG. 10 are a voice chat and screenshots illustrating an example fulfillment of a user intent by the integrated design and development server using one or more communication modes.

### DETAILED DESCRIPTION

Examples of this technology relate to the design and development of process applications and, more particularly, to one or more components, systems, and methods of an integrated design and development platform (IDD platform). The IDD platform is configured to assist users, by way of example, in the design, development, deployment, or use of enterprise applications such as process applications, bots, digital applications, data tables, or the like. In other examples, the one or more components, systems and methods may assist in the design and development of process applications integrated with bots. The users may include actors and end users where, by way of example, actors may design, develop, or deploy the enterprise applications and end users such as initiators, approvers, participants, bot users, or other such users may use the enterprise applications.

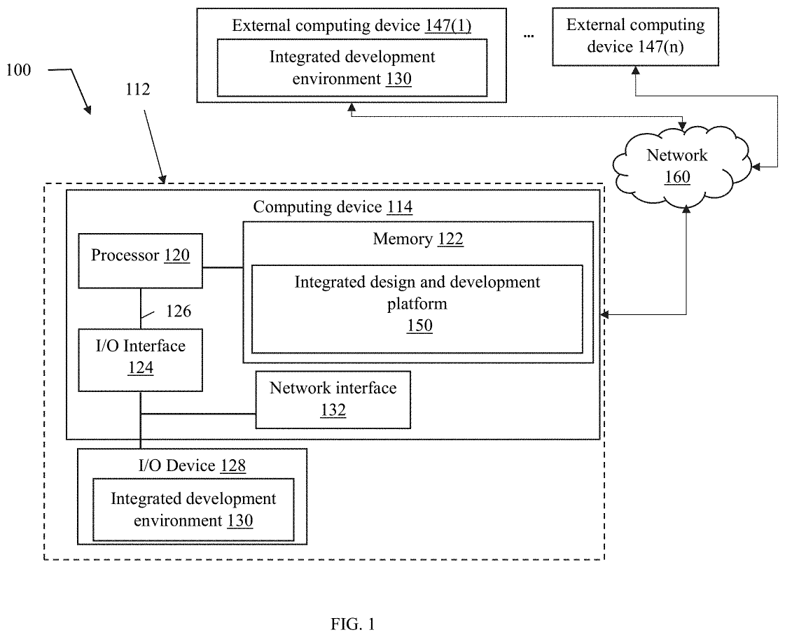

FIG. 1 is a block diagram of an exemplary environment 100 with an example of an integrated design and development platform server configurable to execute an integrated design and development platform. The environment 100 includes an integrated design and development platform (IDDP) server 112, one or more external computing devices 147(1)-147(n), and a network 160, although the environment 100 may include other types or numbers of components, systems, or devices in other configurations.

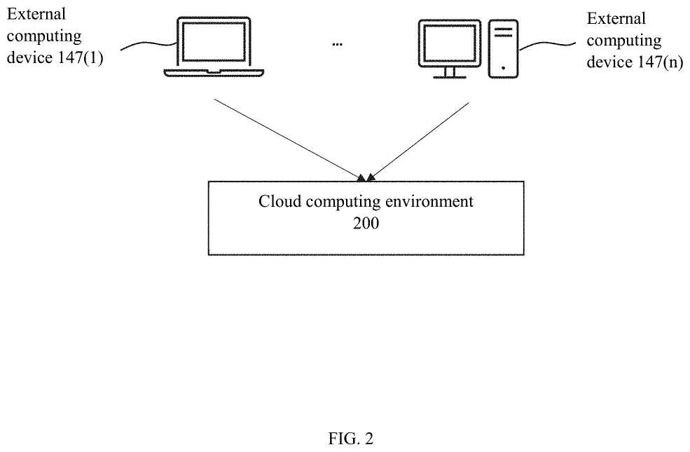

The IDDP server 112 may include a computing device 114 and an input output (I/O) device 128, although the IDDP server 112 may include other types or numbers of components in other configurations. In one example, the IDDP server 112 may include only the computing device 114. The computing device 114 may include a processor 120, a memory 122, an input output (I/O) interface 124, bus 126, and a network interface 132, although the computing device 114 may include other types or numbers of components in other configurations. In addition, the computing device 114 may include an operating system. The IDDP server 112 and/or processes performed by the IDDP server 112 can be integrated into a networking environment (e.g., cloud environment), such as shown in FIG. 2 or any enterprise management system, development tool or other systems.

The processor 120 may comprise one or more central processing units, or general purpose processors with one or more processing cores, such as Intel® processor(s), AMD® processor(s), although other types of processor(s) could be used in other configurations. The processor 120 executes one or more instructions which can be stored in the memory 122. By way of example, the processor 120 may fetch the instructions from a register (not shown), a cache (not shown), or the memory 122. The processor 120 may execute the fetched instructions and write the results to the register, the cache, or the memory 122. It may be understood that the processor 120 may include any types or numbers of registers or caches.

The memory 122 is an example of a non-transitory computer readable storage medium capable of storing information or instructions for the processor 120 to operate on. The instructions, which when executed by the processor 120, perform one or more of the disclosed examples. In one example, the memory 122 may be a random access memory (RAM), dynamic random access memory (DRAM), static random access memory (SRAM), a persistent memory (PMEM), a nonvolatile dual in-line memory module (NVDIMM), hard disk drive (HDD), read only memory (ROM), erasable programmable read-only memory (EPROM), electrically erasable programmable read-only memory (EEPROM), programmable ROM (PROM), flash memory, a CD, a DVD, a magnetic disk, a USB memory card, a memory stick, or a combination of two or more of these. It may be understood that the memory 122 may include other electronic, magnetic, optical, electromagnetic, infrared or semiconductor based non-transitory computer readable storage medium which may be used to tangibly store instructions, which when executed by the processor 120, perform one or more of the disclosed examples. The non-transitory computer readable medium is not a transitory signal per se, and is any tangible medium that contains and stores the instructions for use by or in connection with an instruction execution system, apparatus, or device.

Examples of the programmed instructions and steps stored in the memory 122 are illustrated and described by way of the description and examples herein. As illustrated in FIG. 1, the memory 122 may include instructions corresponding to an integrated design and development (IDD) platform 150, although other types and numbers of instructions in the form of programs, functions, methods, procedures, definitions, subroutines, or modules, may be stored in the memory 122. The IDD platform 150 may be served from and/or hosted on the IDDP server 112 and may be accessible as a website, a web application, or a software-as-a-service (SaaS) application. Users such as the actor or the end user may access the functionality of the IDD platform 150 through the I/O device 128 or the one or more external computing devices 147(1)-147(n). In one example, the functionality of the IDD platform 150 may be exposed as the integrated development environment (IDE) 130 rendered in a web page in a web browser executable in the I/O device 128 or the one or more external computing devices 147(1)-147(n). The actor may access the IDE 130 by interacting with user interface (UI) components such as windows, tabs, or icons rendered in the IDE 130. The IDD platform 150 enables the actor to create various process applications in the IDE 130 that are representative of data flows in enterprises. The IDE 130 provides the actor with a set of development tools to create applications such as process applications, bots, digital applications, data tables, or the like.

Moreover, the IDD platform 150 can incorporate artificial intelligence (AI) capabilities, e.g., natural language processing (NLP), machine learning processing, or rules engines, with the integration of other functionality to design and develop process applications. In addition, the IDD platform 150 described herein can be integrated with different application platforms, such as development platforms or development tools or components thereof already existing in the marketplace, e.g., Facebook® Messenger™, Microsoft® Bot Framework™, through plug in architectures.

The I/O interface 124 may include hardware, software, or a combination of hardware and software, providing one or more interfaces for communication between the computing device 114 and the I/O device 128. The bus 126 provides a communications link between each of the components of the computing device 114. The bus 126 includes hardware, software, or a combination of hardware and software, coupling components of computing device 114 to each other. It may be understood that the computing device 114 may include one or more buses 126. The bus 126 may carry information, determine where the information may be sent, or hold control and timing signals required to coordinate information in the computing device 114, although the bus 126 may perform other types of functions in other configurations. By way of example, the bus 126 may include a graphics bus, a memory bus, an Industry Standard Architecture (ISA) bus, an Extended Industry Standard Architecture (EISA) bus, a Micro Channel Architecture (MCA) bus, a Video Electronics Standards Association (VESA) Local bus, a Peripheral Component Interconnect (PCI) bus, a PCI-Express (PCIe) bus, a serial advanced technology attachment (SATA) bus, a Personal Computer Memory Card Industry Association (PCMCIA) bus, an Small Computer Systems Interface (SCSI) bus, or a combination of two or more of these.

The network interface 132 may include hardware, software, or a combination of hardware and software, providing one or more interfaces for communication between the components illustrated in environment 100. In one example, the network interface 132 may provide interfaces between IDDP server 112 and the network 160 or the computing device 114 and the network 160. The network interface 132 may support wired or wireless communication. In one example, the network interface 160 may include a network adapter or a wireless adapter to communicate with the network 160.

The I/O device 128 may include a keyboard, keypad, microphone, scanner, touch screen, trackball, video camera, monitor, mouse, printer, or a combination of two or more of these. It may be understood that the I/O device 128 may include other such devices. In one example, the I/O device 128 may include a display unit such as a monitor capable of displaying a graphical user interface such as an integrated development environment (IDE) 130. In this example the I/O device 128 may also include a touch screen, keyboard, mouse, microphone, or stylus to receive inputs from users.

The one or more external computing devices 147(1)-147(n) may communicate with the IDDP server 112 via the network 160. The one or more external computing devices 147(1)-147(n) may be a desktop, a laptop, a tablet, a smartphone, although the one or more external computing devices 147(1)-147(n) may include other such devices in other configurations. The one or more external computing devices 147(1)-147(n) may include software and hardware capable of communicating with the IDDP server 112 via the network 160. Also, the one or more external computing devices 147(1)-147(n) may render the functionalities exposed by the IDD platform 150 as part of the IDE 130. In one example, the IDE 130 may be used by the actors such as developers, process authors, business analysts, or the like by way of example. The end users such as initiators, approvers, or participants, bot users, or the like, may also access and interact with the functionalities exposed by the IDD platform 150 via the one or more external computing devices 147(1)-147(n). In one example, the IDD platform 150 may be instantiated on the one or more external computing devices 147(1)-147(n). In another example, the one or more external computing devices 147(1)-147(n) and the IDDP server 112 may communicate via one or more application programming interfaces (APIs) exposed by the IDDP server 112.

The network 160 may enable external systems or devices to communicate with the IDDP server 112. The network 160 may include an ad hoc network, an extranet, an intranet, a wide area network (WAN), a virtual private network (VPN), a local area network (LAN), a wireless LAN (WLAN), a wireless WAN (WWAN), a metropolitan area network (MAN), Internet, a portion of the Internet, a portion of the Public Switched Telephone Network (PSTN), a cellular telephone network, a wireless network, a Wi-Fi® network, a WiMAX network, or a combination of two or more such networks. It may be understood that the network 160 may include other types or numbers of networks in other topologies or configurations. The network interface 132 may include any appropriate interface to communicate with any of these networks.

For further illustration, actors such as developers, process authors, business analysts create enterprise automation solutions using the IDE 130. For example, a process author may create a process application, and a developer may create a bot. End users such as initiators, approvers, participants, bot users may use the enterprise automation solutions created by the actors. In one example, the initiator may trigger the process application created by the process author. The approver may receive a notification from the triggered process application and provide a business decision. The participant may provide information corresponding to the triggered process application. The IDD platform 150 may enable the end users to interact with the process applications or other applications created using the IDD platform 150 from a variety of channels such as bots, email, messengers, Twilio®, short messaging service (SMS), web/mobile clients, Microsoft Teams®, or the like. In one example, the end users may experience the applications created using the IDD platform 150 as automations offered by the enterprise. By way of example, the end user may type in: “what is the status of my leave application,” in a bot and receive a response from the bot as: “your leave application is approved.”

For further illustration, the IDDP server 112 may be representative of a digital backend as a service (MBaaS), maintained by a service provider. As should be understood by those of ordinary skill in the art, the MBaaS is a model for providing developers with a way to link their applications to backend cloud storage and Application Programming Interfaces (APIs) exposed by backend applications, while providing features such as user management and integration.

FIG. 2 illustrates exemplary cloud computing nodes such as cloud computing environment 200 and the one or more external computing devices 147(1)-147(n). The cloud computing environment 200 can be used to implement the IDD platform 150. One or more of the cloud computing nodes in the cloud computing environment 200 may be the IDDP server 112 or perform the functions of the IDDP server 112. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with a service provider. In examples, one or more aspects, functions and/or processes described herein may be performed and/or provided via the cloud computing environment 200. It may be understood that implementation of the examples disclosed herein are not limited to the cloud computing environment 200. Rather, examples of this technology are capable of being implemented in conjunction with any other type of computing environment now known or later developed.

As shown, the cloud computing environment 200 may be communicatively coupled with one or more cloud computing nodes such as external computing devices 147(1)-147(n). The types of the one or more external computing devices 147(1)-147(n) shown in FIG. 2 are intended to be illustrative only and can communicate with any type of computerized device over any type of network and/or network addressable connection, by way of example, using a web browser. The one or more external computing devices 147(1)-147(n) may include a laptop computer, desktop computer, tablet, smartphone, and/or other computer system.

Each of the one or more external computing devices 147(1)-147(n) may include a processor, a memory, a user input device such as a keyboard, mouse, a display device, and/or a communication interface, which are coupled together by a bus or other link, although each may have other types and/or numbers of other systems, devices, components, and/or other elements. In examples, the cloud computing nodes may communicate with one another and may be grouped physically or virtually, in one or more networks, such as private, community, public, or hybrid clouds or a combination thereof. This allows the cloud computing environment 200 to offer infrastructure, platforms and/or software as services for which a cloud consumer does not need to maintain resources on a local computing device.

The cloud computing nodes can include a variety of hardware and/or software computing resources, such as servers, databases, storage, networks, applications, and platforms as shown, for example, in FIG. 1. Cloud resources may be on a single network or a distributed network across multiple cloud computing systems and/or individual network enabled computing devices. The cloud computing nodes may be configured, such that the cloud resources provide computing resources to client devices which may be user devices through a variety of service models, such as Software as a Service (SaaS), Platforms as a service (PaaS), Infrastructure as a Service (IaaS), and/or any other cloud service models. The cloud computing nodes may be configured, in some cases, to provide multiple service models to a client device. For example, the cloud computing nodes can provide both SaaS and IaaS to a client device.

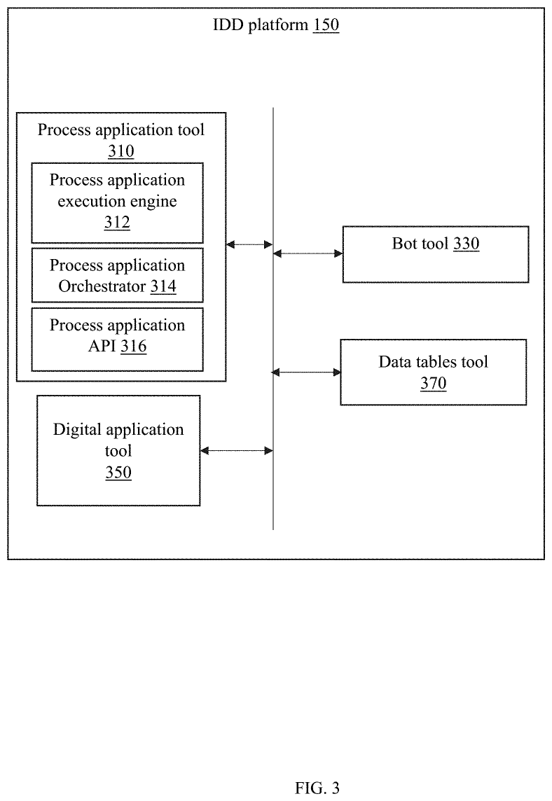

FIG. 3 shows an overview of a functional block diagram of the IDD platform 150 in accordance with aspects of the present disclosure. The IDD platform 150 includes code or instructions for tools, such as a process application tool 310, a bot tool 330, a digital application tool 350, and a data tables tool 370, which may be implemented with artificial intelligence and natural language learning components to provide the functionality as described in the disclosure, e.g., auto-creation of bot task or components in an existing bot or a new bot to check status of a process application instance. It may be understood that the IDD platform 150 may include other types or numbers of tools in other configurations. The IDD platform 150 enables data transfer between the exemplary tools illustrated in FIG. 3. In one example, each tool of the IDD platform 150 may have corresponding API endpoints which may be used for communicating with other tools of the IDD platform 150, and/or with the one or more external computing devices 147(1)-147(n).

Process Application Tool

The process application tool 310 may comprise instructions, algorithms, or models to enable actors and/or end users to: create, deploy, administer, access, or use process applications, or interact with process applications, by way of example, using the IDE 130. In one example, the actors may create, deploy, or administer the process applications and the end users may access, use, or interact with the process applications. The process application may be a sequence of tasks or nodes to process information. The process applications may allow users to automate business processes without the need of code, or with minimum code. The process application tool 310 may include a process application execution engine 312, a process application orchestrator 314, or a process application API 316, although the process application tool 310 may include other types or numbers of units or modules in other configurations.

The process application execution engine 312 is responsible for executing the steps or tasks of the process application. The process application orchestrator 314 identifies, validates, and communicates the process application steps which need to be executed. The collaboration between the components in the process application tool 310 may be enabled, for example, by a message broker. The process application API 316 exposes the underlying functionalities of the process application tool 310 which other tools of the IDD platform 150 such as the bot tool 330, digital application tool 350, data tables tool 370, or external systems can use to manage process application objects or data. The functionalities exposed through the process application API 316, can be, for example, provided by the process application execution engine 312 or the process application orchestrator 314. All the components of the process application tool 310 may use the memory 122 to keep track of process application tasks, configuration, states, values, or execution history.

Bot Tool

The bot tool 330 may comprise instructions, algorithms, or models to enable actors and/or end users to: create, deploy, administer, access, or use the bots, or to interact with the bots, by way of example, using the IDE 130. In one example, the actors may create, deploy, or administer the bots and the end users may access, use the bots, or interact with the bots. The bots created in the IDE 130 using the bot tool 330 may be chatbots or virtual assistants which conversationally interact with the users via text or auditory methods. The bot tool 330 may have artificial intelligence, machine learning, or natural language processing capabilities, although the bot tool 330 may have other types or numbers of capabilities in other configurations. The bot tool 330 may receive an utterance from the I/O device 128 or the one or more external computing devices 147(1)-147(n) operated by the end user, determine the end user intent from the utterance, and execute a bot definition corresponding to the end user intent to prepare a response to the utterance, and output the response to the I/O device 128 or the one or more external computing devices 147(1)-147(n). In one example, executing the bot definition may include making API calls to endpoints corresponding to the process application tool 310, digital application tool 350, data tables tool 370, or external systems.

Digital Application Tool

The digital application tool 350 may comprise instructions, algorithms, or models to enable actors and/or end users to: create, deploy, administer, access, use the digital applications, or to interact with the digital applications, by way of example, using the IDE 130. In one example, the actors may create, deploy, or administer the digital applications and the end users may access, or use the digital applications, or interact with the digital applications. The digital application tool 350 enables users to create, deploy, administer, access, or use software applications using low-code or no-code methods.

Data Tables Tool

The data tables tool 370 may comprise instructions, algorithms, or models to enable actors and/or end users to: create, deploy, administer, access, or use data tables, or to interact with data tables, by way of example, using the IDE 130. In one example, the actors may create, deploy, or administer the data tables and the end users may access or use the tables, or interact with the data tables. The data tables may be used for storing and managing data corresponding to the bots. One or more data tables may be joined to create data views. Data tables and data views may be assigned to bots for accessing the data. In one example, APIs may also be used to access the data in the data tables.

For further illustration, the tools of the IDD platform 150 may allow data access via APIs. In one example, each of the process application tool 310, bot tool 330, digital application tool 350, or the data tables tool 370 may allow the other tools of the IDD platform 150 to access their data. For example, the process application tool 310 may enable a bot created using the bot tool 330 to access the data corresponding to a process application created using the process application tool 310. In another example, the data tables tool 370 may enable a bot created using the bot tool 330, or a process application created using the process application tool 310 to use a data table created using the data tables tool 370. Each tool of the IDD platform 150 may communicate with other tools of the IDD platform 150 or with external systems using APIs.

Each tool of the IDD platform 150 may be rendered in the IDE 130 and may be accessed or used by different users involved in enterprise automation. The actors may use the I/O device 128 or the one or more external computing devices 147(1)-147(n) to access the IDE 130. By way of example, the actors such as a process author or a business analyst may use the process application tool 310 and the actors such as a developer or a bot designer may use the bot tool 330. The process author may create process applications using the process application tool 310.

End users such as an initiator, approver, or participant may trigger the process application, provide information, or interact with the information corresponding to the process application. The initiator may trigger a process application by, for example, conversing with a bot, filling a form, or the like. The approver or participant may receive the information or details input by the initiator and perform an action on the received details. By way of example, the action may be an approval or a rejection. In one example, the initiator may apply for a leave by submitting a digital leave form which triggers a leave request process application upon submission. The process application, based on its configuration, may assign the leave application of the initiator to the approver for an approval or rejection. The approver may receive a notification that the leave application is awaiting an approval or a rejection. Subsequently, the approver may choose to approve or reject the leave application, for example, by selecting the approve or the reject button in a graphical user interface rendered in the approver's user device. The process application, based on its configuration, may provide information related to the leave applications processed by the leave request process application to the participants. In some examples, the participants may provide additional information required by the approver to arrive at a decision.

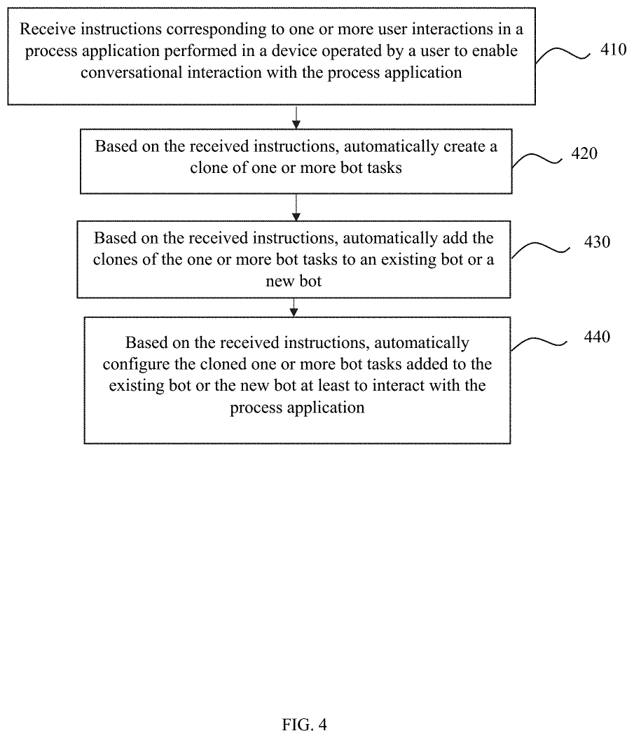

FIG. 4 illustrates a method to auto create bot tasks which enable conversational interaction with a process application. Conversational interaction with the process application comprises a bot, by way of example created using the bot tool 330, receiving an utterance corresponding to the process application, by way of example created using the process application tool 310, in natural language from the end user, determining the end user intent from the utterance, making a web request such as an API call to a process application endpoint, receiving a response from the process application endpoint, and providing a response to the utterance in natural language. The process application endpoints may include, by way of example, a get-status-API endpoint, a get-pending-actions-API endpoint, a get-details-API endpoint, or a perform-action-API endpoint. In one example, the conversational interaction with the process application comprises a bot receiving an utterance: “what is my leave application status,” and the bot providing a response to the utterance as: “your leave is approved.” The bot may communicate with the process application to determine the response to the utterance.

At step 410, the IDDP server 112 may receive instructions corresponding to one or more user interactions in a process application in the IDE 130 to enable conversational interaction with the process application. The one or more user interactions may be performed by the user such as the actor accessing the process application in the IDE 130 using the I/O device 128 or the one or more external computing devices 147(1)-147(n). The one or more user interactions may include a first selection, a second selection, and a third selection, although the one or more user interactions may include other types or numbers of selections in other configurations.

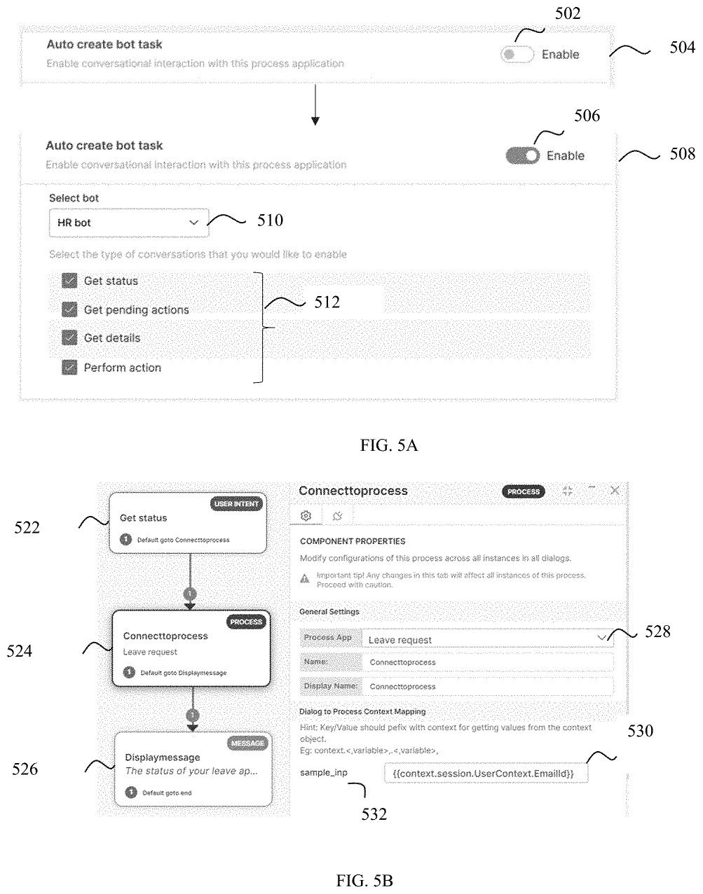

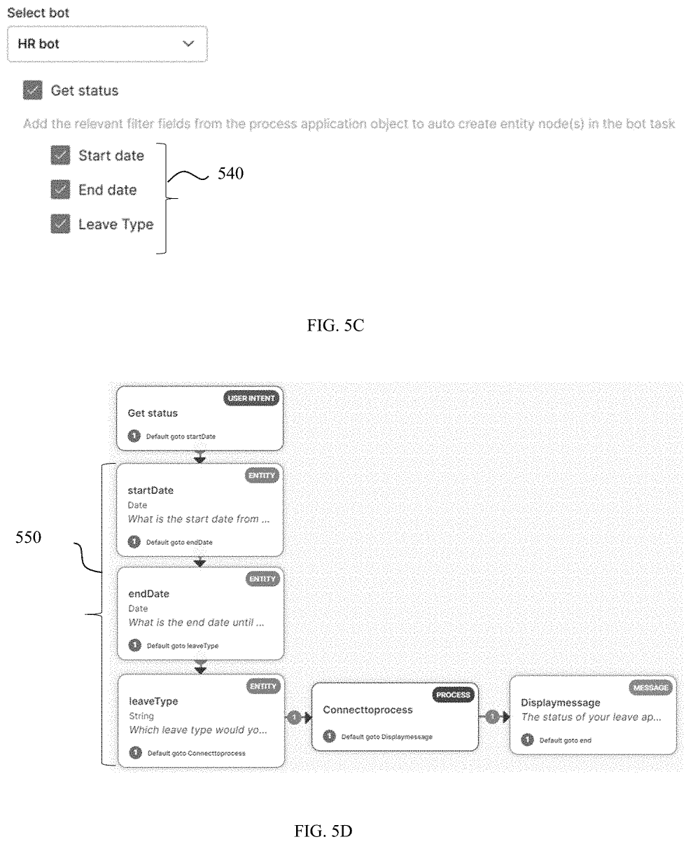

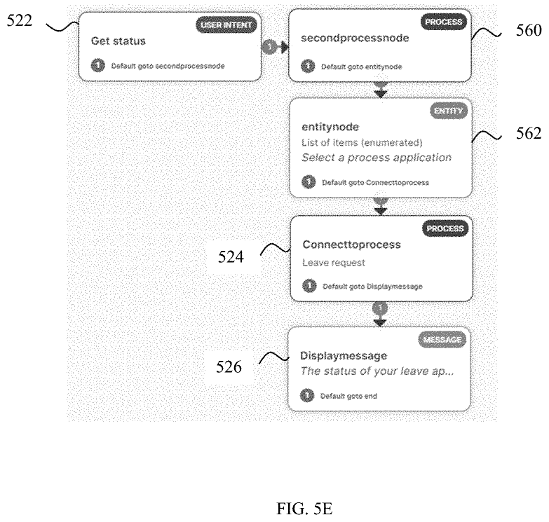

The first selection may include the actor selecting an option, when accessing the process application in the IDE 130, to enable conversational interaction with the process application. FIG. 5A is a partial flowchart and a partial screenshot of an exemplary transition of a display state of the IDE 130 corresponding to the process application. An example of the first selection in the process application in a first section of the IDE 130 is illustrated in FIG. 5A. In this example, the first section may correspond to settings of a leave request process application, although the first section may correspond to other features of the process application in other configurations. The first section may be displayed in a first state 504. The first selection may include the actor such as the process author, developer, or the bot designer changing the OFF state 502 of the toggle button to ON state 506 to auto create bot tasks. Based on the first selection, the display of the first section may be transitioned from the first state 504 to a second state 508.

The second selection may include the actor, when accessing the process application in the IDE 130, selecting one or more bot tasks to be added to an existing bot or a new bot. An example of the second selection in the process application in the IDE 130 is illustrated in FIG. 5A. The actor may be provided options to select one or more bot tasks 512 to be added to an existing bot or a new bot. The actor may be provided an option to add the selected one or more bot tasks to an existing bot or a new bot using a drop-down component 510. In this example, the actor may choose to add the selected one or more bot tasks to an existing HR bot. In other examples, the actor may choose to add the selected one or more bot tasks to a new bot. Further, the actor may choose to add a first one of the one or more bot tasks to a first bot and a second one of the one or more bot tasks to a second bot. For example, the actor may choose to add a get-status bot task to the HR bot, and the get-pending-actions bot task to a leave management bot.

When the actor chooses to add the selected one or more bot tasks 512 to an existing bot, all the existing bots accessible by the actor may be displayed for selection in the drop down 510. In one example, all the existing bots accessible by the leave request process application may be displayed for selection in the drop down 510. In another example, all the existing bots accessible by both the actor and the leave request process application may be displayed for selection in the drop down 510. The actor may select an existing bot to add the one or more bot tasks 512 and based on the selection of the existing bot, the IDDP server 112 may determine if the selected existing bot has a permission to interact or communicate with the leave request process application. If the selected existing bot does not have the permission, the IDDP server 112 may grant the selected existing bot permission to interact or communicate with the leave request process application. Further, the IDDP server 112 may determine if the selected one or more bot tasks 512 already exist in the selected existing bot. If yes, the IDDP server 112 may not create a duplicate of the selected one or more bot tasks 512 in the selected existing bot.

The third selection may include the actor, when accessing the process application in the IDE 130, selecting one or more filter fields as entities to be included in one or more bot tasks. The one or more filter fields may be used by the IDDP server 112 to request information from the actor and retrieve results from the memory 122. In one example, for the leave request process application, the filter fields may be start_date, end_date, leave_type, or the like. The actor accessing the leave request process application in the IDE 130 may select one or more of: start_date, end_date, leave_type, and associate them with, by way of example, get-status-bot task.

Referring back to FIG. 4, at step 420, based on the instructions received corresponding to one or more user interactions in the process application received at step 410, the bot tool 330 of the IDDP server 112 automatically creates a clone of one or more sample bot tasks. In one example, the bot tool 330 of the IDDP server 112 may create the clone of the one or more bot tasks based on the instructions received corresponding to the second selection of the one or more sample bot tasks in the process application in the IDE 130. In another example, the bot tool 330 of the IDDP server 112 may automatically create a clone of one or more bot tasks by default upon determining a change from OFF state 502 to ON state 506 in the process application in the IDE 130.

In examples, the one or more bot tasks may include: get status, get pending actions, get details, perform action, or the like by way of example. The get status bot task may enable the end user such as a process application initiator to conversationally check the status of a request, for example a leave request. The get pending actions bot task may enable the end user such as an approver or a participant to conversationally request pending actions corresponding to the approver or the participant. The get details bot task may enable the end user such as the approver or the participant, to conversationally request and view details corresponding to the pending action. The perform action bot task may enable passing the action information, such as selection of an approval or rejection corresponding to a pending action, to the memory 122 corresponding to the process application instance. In one example, the part of the memory 122 corresponding to the process application instance may be persistent including a database collection, a database table, a database row, a database column, or a database record. It may be understood that the IDDP server 112 may create clones of other such bot tasks having other features. At step 420, the clones of one or more bot tasks may include training data such as machine learning utterances, patterns, rules, synonyms, or the like.

At step 430, the bot tool 330 of the IDDP server 112 may, based on the instructions corresponding to one or more user interactions in the process application received at step 410, automatically add the cloned one or more bot tasks to an existing bot or a new bot. By way of example, the bot tool 330 of the IDDP server 112 may automatically add the cloned one or more bot tasks to an existing bot or a new bot based on the instructions received corresponding to the second selection. In the example illustrated in FIG. 5A, the user such as the actor selects to add the cloned one or more bot tasks to the HR bot. As a result, the cloned or more bot tasks may be added to the HR bot.

At step 440, the bot tool 330 of the IDDP server 112 may, based on the instructions corresponding to one or more user interactions in the process application received at step 410, automatically configure the cloned one or more bot tasks added to the existing bot or the new bot at least to interact with the process application. The automatic configuration of the cloned one or more bot tasks added to the existing bot or the new bot may also include adding training information, entity recognition, or the like. The automatic configuration of the cloned one or more bot tasks added to the existing bot or the new bot modifies the bot definition of the existing bot or the new bot, by way of example, by adding training information, adding API call configuration, adding entity recognition configuration, or the like, to the bot definition. The training information, the API call configuration, or the entity recognition configuration may be automatically added to the bot definition based on, by way of example, the process application in which the one or more user interactions are performed. Parameters of the process application such as name of the process application, process application identifier, fields corresponding to process application object such as filter fields, or the like, may be used to perform the automatic configuration. In one example, bot tool 330 of the IDDP server 112 may automatically configure the process application name or a process application identifier to the cloned one or more bot tasks added to the existing bot or the new bot. In another example, the bot tool 330 of the IDDP server 112 may, in the one or more bot tasks, configure a web request such as an API call with the process application identifier.

Automatic configuration of the cloned one or more bot tasks added to the existing bot or the new bot may include adding API call configuration to the cloned one or more bot tasks added to the existing bot or the new bot. The end user may communicate with the IDDP server 112 via the network 160 using the one or more external computing devices 147(1)-147(n). The IDDP server 112 may send the outputs from the HR bot to the one or more external computing devices 147(1)-147(n). The selections or responses provided in the one or more external computing devices 147(1)-147(n) may be received by the IDDP server 112. FIG. 5B is a partial flowchart and a partial screenshot of an exemplary configuration of the auto created get-status-bot task as displayed in the IDE 130. An example of automatic configuration by adding API call configuration as described in step 440 is illustrated in FIG. 5B. FIG. 5B includes the automatic configuration of the get status bot task added to the HR bot displayed in a second section of the IDE 130. The partial flowchart and partial screenshot illustrated in FIG. 5B is a high-level representation of the HR bot definition. Editing the user interface components illustrated in FIG. 5B modifies a low-level representation of the HR bot definition which may be, by way of example, a JavaScript Object Notation (JSON) file. The get-status-bot task may include an intent node 522, a process node 524, or a message node 526. It may be understood that the get status bot task may include other types or numbers of nodes such as entity nodes, service nodes, or the like, in other configurations. When the get status bot task is added to the HR bot at step 430, the HR bot definition may be modified to respond to utterances requesting a status corresponding to the leave request process application. An example utterance requesting the status corresponding to the leave application may be “what is my sick leave status.”

The process node 524 may be capable of communicating with the leave request process application. In one example, as part of the automatic configuration, the IDDP server 112 may configure an API call made by the process node 524 to the get-status-API endpoint with the process application name 528 or the process application identifier, although other variables or identifiers may be used to configure the process node 524. After the automatic configuration, the process node 524 is configured to make the API call to the get-status-API endpoint. Each process application name 528 may have a corresponding process application identifier. The IDDP server 112 may include code or instructions to use the process application name or the process application identifier, for example, in the API call to the get-status-API endpoint. The process node 524 may also be configured to pass an email address of the user such as the initiator in the API call to the get-status-API endpoint. The IDDP server 112 may also pass the email address of the initiator to the get-status-API endpoint using other methods. The status of the leave applications corresponding to the email address is retrieved by the get-status-API endpoint from, by way of example, a database collection in the memory 122 and output to the HR bot which provides the response to the utterance. The message node 526 of the HR bot formats the output from the get-status-API endpoint into the response based on the configuration of the message node 526.

Automatic configuration of the cloned one or more bot tasks added to the existing bot or the new bot may include adding training information to the cloned one or more bot tasks added to the existing bot or the new bot. The intent node 522 of the get status bot task includes configuration and training data to enable the IDDP server 112 determine if the intent of an utterance is to get status corresponding to the leave request process application. To determine the intent of the utterance, the HR bot may be automatically trained by adding training utterances such as “get <process application name> status,” “what is my <process application name> status,” “is my <filter_field> approved,” or the like. In this example, as the process application name is “leave request,” and leave_type such as sick leave, privileged leave is a filter field, the training utterances may include “get leave request status,” “what is my leave request status,” “is my sick leave approved.” In one example, the training utterances may be added to the intent node 522 to identify the utterances whose intent is to get a leave application status, although the training may enable identifying other types of status in other configurations. The automatic configuration may also include adding synonyms to the intent node 522. For example, synonyms to the words get, status may be automatically added to the intent node 522, when the get status bot task is cloned and added to the HR bot.

The automatic configuration of the cloned one or more bot tasks added to the existing bot or the new bot may include adding entity configuration to the cloned one or more bot tasks added to the existing bot or the new bot. An entity may include information required by the bot tool 330 to formulate a response to an utterance received by the bot tool 330. In one example, the entity may be a city, a date, a datetime, a country, an airport, a zip code, a color, or the like. FIG. 5C is a partial screenshot of a third selection in the process application in the IDE 130. The entity configuration may be added to the bot definition based on the filter fields 540 selected by the user such as the actor in the process application. In one example, the <start_date>, <end_date>, and <leave_type> filter fields 540 are selected by the actor in the leave request process application. The entity configuration corresponding to these filter fields 540 are added to the part corresponding to the get status bot task in the bot definition of the HR bot.

FIG. 5D is a flowchart of an example of get status bot task created based on the third selection made by the actor in the IDE 130. The bot tool 330, as a high-level representation of the bot definition adds three entity nodes 550 to the get status bot task—one each corresponding to: the start_date, end_date, and leave_type filter fields 540. The entity nodes 550 corresponding to the start_date and end_date filter fields 540 may be date type entity nodes and the entity node corresponding to the leave_type may be a string type entity node. The entity configuration improves the ability of the bot tool 330 to determine responses to utterances from the users.

FIG. 5E is a partial flowchart and partial screenshot of an exemplary configuration of the auto created get status bot task as displayed in the IDE 130. In this example the get status bot task is a part of the HR bot. The FIG. 5E includes the intent node 522, the process node 524, and the message node 526 illustrated in FIG. 5B. Additionally, the FIG. 5E includes a second process node 560 and an entity node 562. Upon receiving the utterance in the HR bot, the intent node 522 configuration may be used by the HR bot to determine the user intent of the utterance. The second process node 560 configuration may be used to retrieve the process applications accessible by the HR bot, and the HR bot is configured such that the accessible process applications are output as list of items (enumerated) by the entity node 562. The list of items is displayed to the end user by one of the one or more external computing devices 147(1)-147(n). The end user may select one of the process applications displayed as a list of items. Based on the selection, the process node 524 may be configured to make the API call to the get-status-API endpoint, and to include the process application identifier of the selected process application and email address of the end user as part of the API call. Subsequently, as described above with respect to FIG. 5B, the HR bot receives an output from the get-status-API endpoint and based on the output provides the response to the utterance. The HR bot of the IDDP server 112 may output the response in the one of the one or more external computing devices 147(1)-147(n).

In one example, the end user may, while accessing the HR bot of the IDDP server 112 in the one of the one or more external computing devices 147(1)-147(n), provide an input: “what is the status of my application.” The HR bot may determine that the user intent of the input is to “get status.” Subsequently, the second process node 560 based on output of an API call to an endpoint enabled by the process application API 316, determines that the HR bot has access to the leave request process application and an insurance claim process application. The second process node 560 may output information about the accessible process applications to the entity node 562. The entity node 562 may output: “Select 1. Leave request process application 2. Insurance claim process application.” Upon receiving the end user selection as “1”, the process node 524 may be configured to make the API call to the get-status-API endpoint, and include the leave request process application identifier and the email address of the end user as part of the API call. Subsequently, as described above with respect to FIG. 5B, the HR bot receives an output from the get-status-API endpoint, and based on the output provides the response to the utterance based on the message node 526 configuration. It may be understood that the end user may access (e.g. view, hear, or the like) the outputs from the HR bot and provide inputs to the HR bot using the one or more external computing devices 147(1)-147(n).

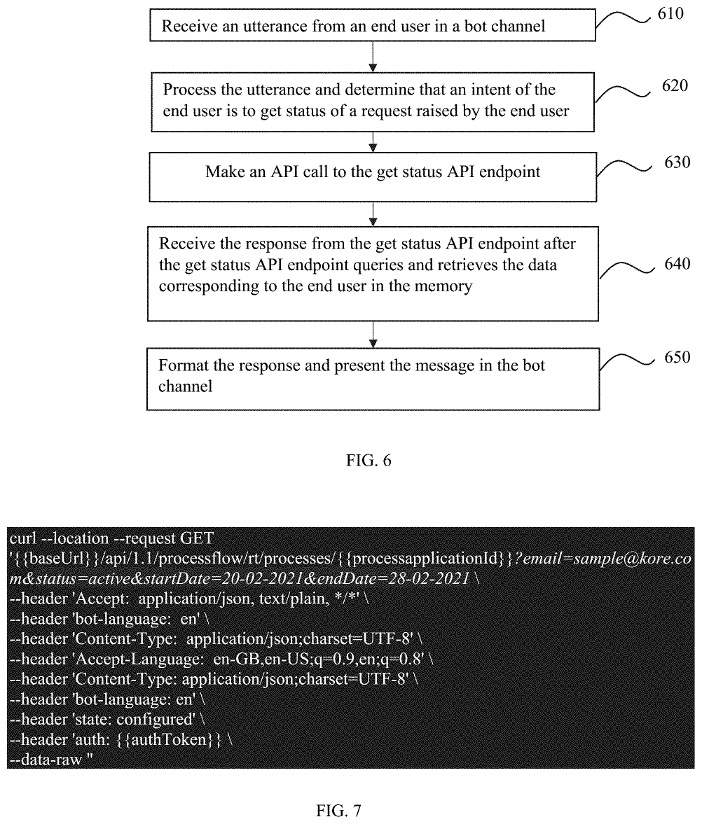

FIG. 6 is a flowchart of an example of a method to execute an auto-created get status bot task. In one example, the auto-created get status bot task may determine an intent of the utterance received by the bot tool 330 in a bot channel using the intent node 522, make a web request, such as an API call, to the get-status-API endpoint managed by the process application API 314 using the service node or the process node 524. Further, the auto-created get status bot task may receive a response from the get-status-API endpoint, process the received response, and display a message in a bot channel using the message node 526. In another example, the message may be displayed in a bot channel configured in another bot configured to display the notifications.

By way of example, the auto-created get status bot task may be created based on one or more user interactions performed in the leave request process application. At step 610, the bot tool 330 of the IDDP server 112 receives an utterance from the user such as the end user in a bot channel. In one example, the end user may be accessing the I/O device 128 or the one or more external computing devices 147(1)-147(n). The end user may be an initiator, an approver, or a participant of the process application. In this example, the utterance may be “what is the status of my leave application.”

At step 620, the bot tool 330 of the IDDP server 112 processes the utterance and determines that an intent of the end user is to get status of a request raised by the end user. In this example, the intent of the end user may be “get status.”

At step 630, the IDDP server 112 may make an API call to the get-status-API endpoint. In this example, the bot tool 330 of the IDDP server 112 may, at step 630, make the service call, such as an API call to the get status endpoint managed by the process application API 314.

The bot tool of the IDDP server 112 may use, by way of example, a GET method call or a POST method call to query the data. The GET method call may include the auto configured leave request process application identifier. The email address of the end user may also be passed in the GET call or the POST call to query the data, although other types of API calls may be used to pass the email address. In one example, the email address of the end user may be passed using backend code or as a part of the payload in the GET call or the POST call. The payload in the GET call or the POST call may also include filter fields, such as start date, end date, leave type, a date range, day, datetime, or other such parameters. The email address of the end user may also be retrieved by the get-status-API endpoint by using an account identifier sent as part of the payload of the GET call or the POST call. It may be understood that the end user may be identified using other identifiers such as a user identifier, an account identifier, or the like. Based on the email address of the end user, the records corresponding to the end user may be output by the get-status-API endpoint as a response to the GET call or the POST call.

An example of step 630 is illustrated in FIG. 7. FIG. 7 is a listing of code for an example GET call configuration to the get-status-API endpoint. The GET call is made to the get-status-API endpoint and passes a process application identifier, an email address, status, start date, and an end date to retrieve leave data corresponding to the initiator. The get-status-API endpoint may provide a response to the GET call in the form of a JSON object comprising key value pairs. The bot tool 330 of the IDDP server 112 may receive the response and, using the information in the JSON object, create a message to be displayed to the initiator in the bot channel.

Referring back to FIG. 6, at step 640, the bot tool 330 of the IDDP server 112 may receive a response from the get-status-API endpoint after the get-status-API endpoint queries and retrieves the data corresponding to the end user in the memory 122 which may include, by way of example, one or more database tables, or database collections, although the data corresponding to the process application may be stored in other types of systems or software. The response to the GET call or the POST call may be output by the get-status-API endpoint in the form of a JSON object. The JSON object may include key value pairs which disclose the status of the leave applications corresponding to the end user, such as: pending or approved. In this example, the JSON object may include a key value pair indicating that the status of the leave application as—pending.

At step 650, the bot tool 330 of the IDDP server 112 may format the response received from the GET method call as a message and present the message to the initiator in the bot channel in which the utterance is received. In this example, the message in the bot channel may be “your leave application is pending.” For the auto-created get status bot task, by way of example, the end user may be an initiator.

For the get pending actions bot task, by way of example, the end user may be an approver or a participant. In one example, when the bot tool 330 of the IDDP server 112 receives an utterance “get pending actions” from an approver or a participant, the IDDP server 112 determines the intent of the utterance and the IDDP server 112 makes an API call to the get-pending-actions-API endpoint. The IDDP server 112 may pass the email address of the approver or the participant available in the user context memory to the get-pending-actions-API endpoint. The user context memory may be a part of the memory 122. The get-pending-actions-API endpoint may query the memory 122 using the email address of the approver or the participant, retrieve the corresponding records and send them to the IDDP server 112. The bot tool 330 of the IDDP server 112 receives the retrieved records, as part of the response to the API call, from the get-pending-actions-API endpoint. Further, the bot tool 330 of the IDDP server 112 formats the response and outputs instructions which enable display of a list of pending actions corresponding to the approver or the participant. In this example, as the bot tool 330 retrieves all the pending actions from all the process applications, the bot tool 330 may not include the process application identifier in the API call.

In examples, actors, such as the process author or the developer, select the HR bot for auto-creation of dialogs while configuring the leave request process application and an insurance process application. In this example, the bot tool 330 of the IDDP server 112 receives an utterance “get pending actions requested this week,” from the end user in the HR bot. Subsequently, the HR bot may make one or more API calls to the get-pending-actions-API endpoint, and include the email address of the end user, the process application identifiers of the leave request process application and the insurance process application in the one or more API calls. The HR bot may receive the response corresponding to the one or more API calls, format the response and display a message to the end user. It may be understood that, as the HR bot is selected for auto-creation of dialogs while configuring the leave request process application and the insurance process application, when the end user inputs “get pending actions requested this week,” in the HR bot, the end user may only receive pending actions of the user corresponding to the leave request process application and the insurance process application. Further, the IDDP server 112 may determine an entity of entity type: date range in the utterance. The determined entity may also be used as a parameter or in the payload of the one or more API calls.

A bot may be associated with multiple process applications. More specifically, a bot may be a conversational trigger to multiple process applications. In one example, the HR bot may be associated with the leave request process application and the insurance process application. In this example, when an end user types in an utterance “get my status” in the HR bot, the IDDP server 112 may not be able to determine if the utterance corresponds to the leave request process application or the insurance process application. The IDDP server 112, to resolve the ambiguity, may output instructions resulting in the HR bot displaying “Please select the process application 1. Leave request 2. Insurance, to get status.”

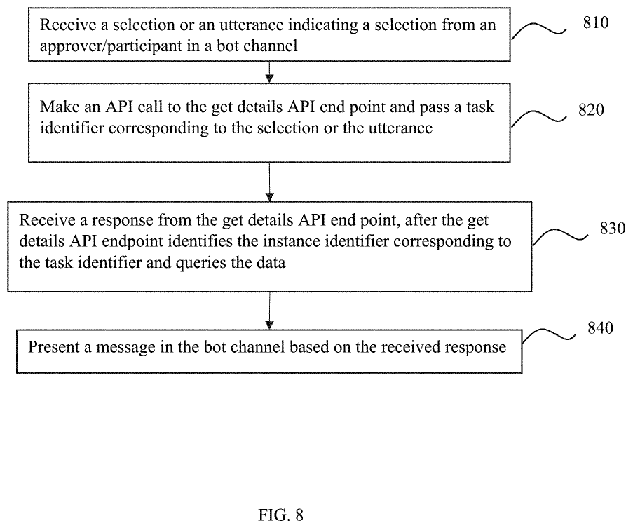

FIG. 8 is a flowchart of an example of a method of executing an auto-created get-details bot task. An approver or a participant accessing the I/O device 128 or one or more external computing devices 147(1)-147(n) may type in the utterance —“what are my pending actions” in a bot channel enabled by the IDD platform 150. The IDDP server 112 may receive and analyze the utterance. In one example, the approver or the participant accessing the I/O device 128 or the one or more external computing devices 147(1)-147(n) may provide the utterance as a voice input in the bot channel. The voice input may be provided to the IDDP server 112 which transcribes the voice input using voice recognition and natural language processing techniques. The IDDP server 112 may analyze the resultant transcribed utterance. In another example, the IDDP server 112 may communicate with external text-to-speech converting services to obtain the transcribed utterance.

The bot tool 330 of the IDDP server 112 may determine the intent of the utterance as “get pending actions.” The bot tool 330 may invoke the bot task corresponding to the “get pending actions” intent and make an API call to the get-pending-actions-API endpoint, managed by the process application API 314, and receive a corresponding response. Based on the response, the IDDP server 112 may output instructions to enable display of the pending actions in the process application corresponding to the approver or the participant. The pending actions may be displayed in the bot channel. For example, based on the utterance, the IDDP server 112 may output instructions to display “Your pending actions are: 1. Leave approval request from John <more details> 2. Leave approval request from Smith <more details>.” Each of the pending actions may have a corresponding task identifier created in the memory 122, for example, when the process application is triggered by the initiator.

At step 810, the IDDP server 112 may receive a selection or an utterance indicating a selection from an approver or a participant in a bot channel. In this example, the approver or the participant may select “more details” corresponding to option 1 in the bot channel. In examples, the end user such as the approver or the participant may instead of the selection, type in an utterance “more details on option 1” in the bot channel as an indication of selection of “more details” button of option 1.

At step 820, the IDDP server 112 may make an API call, such as a GET call or a POST call, to the get-details-API endpoint and pass the task identifier corresponding to the selection or the utterance as part of the GET call or the POST call. Subsequently, the get-details-API endpoint may query the memory 122 based on the task identifier and compile the response.

At step 830, the IDDP server 112 may receive a response from the get-details-API endpoint. In examples, the response may include key value pairs disclosing additional information about the leave application from John. The get-details-API endpoint may identify a process application instance identifier corresponding to the passed task identifier and query the details corresponding to the process application instance identifier. The get-details-API endpoint may output the result of the query as a response to the API call, made at step 820, to the IDDP server 112.

Based on the response, the IDDP server 112 may, at step 840, present a message to the approver or the participant in the bot channel. In this example, the message may be “John has requested planned leave from Mar. 21, 2021 to Mar. 25, 2021.”

In one example, the one or more bot tasks may make API calls to the same API endpoint. For example, the get status bot task, the get pending actions bot task, the get details bot task, and the perform action bot task may make GET, POST, PUT, PATCH, or DELETE calls to the same API endpoint.

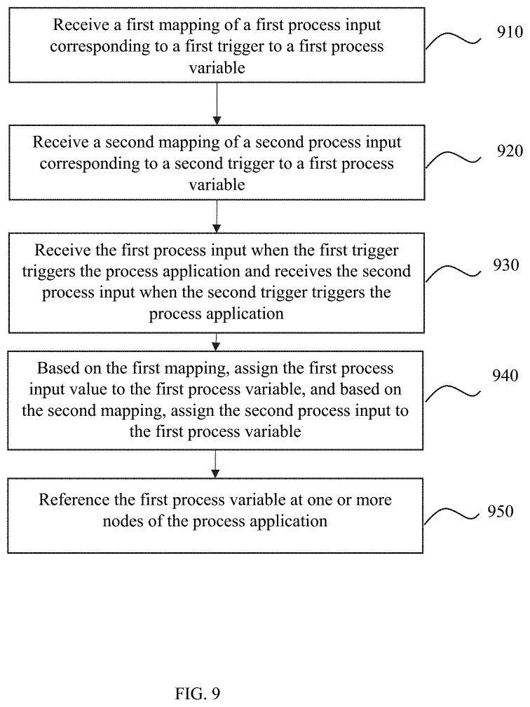

FIG. 9 is a flowchart of an example of a method to assign one or more process inputs corresponding to one or more process triggers to a single process variable corresponding to the process application in the IDE 130 of the IDD platform 150 executed by IDDP server 112. The process application may be triggered using one or more process triggers such as a bot, a form, from a node of a bot (conversational trigger), email client, a webhook, another process application, time-based trigger, or the like. In examples, an actor may select one or more process triggers in the process application user interface to trigger the process application. Each process trigger may pass one or more process inputs to the process application. The one or more process inputs from each process trigger may be associated with one or more process variables which may be referenced in the process application, for example, in the process application user interface. Associating process inputs to process variables provides ease of configuring the process application.

At step 910, the IDDP server 112 receives a first mapping of a first process input, corresponding to a first trigger, to a first process variable. In examples, the first trigger of the process application may be a bot. For example, the bot may trigger the process application when the bot receives an entity. The bot may pass the first process input to the process application when the bot triggers the process application.

An example of the bot passing the process input to the process application is illustrated in FIG. 5B. The actor configuring the process application may have an option to configure the process input 532. The process input 532 may be automatically displayed in the IDE 130 for the bots which have the permission to trigger the process application. This improves the ease of passing variables from the bot to the process application. In this example, the process input—email_id may be configured in the leave request process application. The HR bot may also be configured as the conversational trigger to trigger the leave request process application. As a result, the process input 532—email_id may be displayed in the IDE 130 section corresponding to the HR bot. The user may choose to assign a context variable 530 such as {{context.session. UserContext. Emailid}} to the process input 532—email_id. The email_id from the context variable 530 may be passed to the leave request process application when the HR bot triggers the leave request process application.

At step 920 in FIG. 9, the IDDP server 112 receives a second mapping of a second process input, corresponding to a second trigger, to a second process variable. In examples, the second trigger may be form-based and the second trigger may trigger the process application using a form. For example, the form may trigger the process application when a “submit” button of the form is selected. The form may pass the second process input to the process application when the form triggers the process application. The first mapping and the second mapping may be performed, by way of example, while configuring the process application in the IDE 130.

At step 930, the IDDP server 112 receives the first process input when the first trigger triggers the process application and receives the second process input when the second trigger triggers the process application.

At step 940, the IDDP server 112, based on the first mapping, assigns the first process input value to the first process variable and based on the second mapping, assigns the second process input to the first process variable.

At step 950, the IDDP server 112 enables referencing the first process variable at one or more nodes of the process application.

Triggers

A bot may trigger the process application upon completion of a task, submission of a form in the bot, or the like. A form may trigger the process application when the form is submitted. A conversational trigger includes triggering the process application at a specific stage in a dialog flow of a bot. In one example, the conversational trigger may include a node in a bot triggering the process application when the dialog flow reaches the node. An email client may trigger the process application based on business rules such as, for example, subject contains <text>, or a body of the email starts with <text>, or the like. A webhook may trigger the process application based on an event. The process application may also be triggered by another process application. The process application trigger may be scheduled at a specific time (time-based trigger).

Overriding Notification Settings

The process application may deliver notifications in one or more channels such as email, instant messengers, bots, or the like. The channel in which the notifications are delivered may be configured in the process application user interface. The notification settings in a process application may be configured at a global level or at a node level. The global settings may be applicable to all the nodes of the process application and the local level settings may be applicable to a specific node of the process application. The global notification settings may be overridden at a node of the process application. In one example, the global notification setting may be to deliver notifications via email. However, at an approval task node of the process application the global notification setting may be overridden and may be configured to deliver notifications, for example, using Slack®. Based on this setting, the process application delivers notifications via email and specifically deliver approval task notifications via Slack®.

For further illustration, process applications can be created using drag and drop methods, configured, and easily integrated with other applications in the IDD platform 150. Further, the IDD platform 150 enables data transfer between a process application, a bot, a digital application, or a data table.

In examples, the features of the IDD platform 150 may be accessed using a graphical user interface (GUI) with tabs to create process applications, bots, digital applications, or data tables. For example, the GUI may enable a process author to:

(a) drag and drop components into a workspace, connect the components and configure the components to create the process application;

(b) simulate the process application;

(c) check insights generated from process application instances;

(d) define members and their roles, create, and maintain versions of the process application; and/or

(e) maintain an audit log.

By way of other examples, the components, systems, and methods described herein can be used by the actor, such as the developer, the process author, or a business analyst, to create multiple process applications which automate business processes. Each process application may include complex paths including: components, such as triggers; task components, such as an approval task, input task, invocation task, or script task; integration components, such as database connectors, or application programming interface (API) connectors, delay components, flow connectors, such as merge, split, go to, end; or the like.

The IDDP server 112 may receive instructions based on the interactions performed in the IDE 130 in the one or more external computing devices 147(1)-147(n), process the received instructions and outputs instructions which may be at least partly used by the one or more external computing devices 147(1)-147(n) to render a response to the interactions performed in the IDE 130. The IDE 130 may be a visual interface rendered to enable users to access the tools and other functionalities offered by the IDDP server 112, although other types or numbers of interfaces may be provided or rendered in other configurations.

The IDD platform 150 can, in examples, enable integration of the process applications with other applications such as bots, digital applications, data tables, or the like. In examples, the IDD platform 150 adds one or more bot tasks to an existing bot which enables an end user to check the status of a process application instance or pending tasks of the process application instance. In one example, a bot task may comprise a bot definition which defines characteristics of the bot. The bot definition may be implemented in various forms. In one example, the bot definition may comprise a data structure including metadata corresponding to intents handled by the bot, frequently asked questions added to the bot, transitions defined in the bot, training provided to the bot, bot channels, bot variables, extensions configured in the bot, or the like. The metadata could be included in a JavaScript Object Notation (JSON) file, an extensible markup language (XML) file, a database table, a database collection, or other such data structures. In another example, the bot definition may include one or more instructions to implement the characteristics of the bot. The bot definition may be accessible and executed by the IDDP server 112, and more specifically bot tool 330 of the IDD platform 150, during runtime. The bot tool 330 may use the bot definitions to understand the utterances received and determine the appropriate responses to the received utterances. The bot tool 330 may communicate with other tools of the IDD platform 150 such as the process application tool 310, digital application tool 350 or data tables tool 370 to retrieve the data required to determine the appropriate responses.

By way of example, a process application may be created in a process application tab in the IDE 130. The process application may be created by dragging and dropping components from a process application component menu into a workspace in the process application tab of the IDE 130 and connecting them using lines, arrows, or flow components. Each component may have properties configurable by the user. Based on the business process to be automated, the user may connect components and configure them in the workspace. The features or functionalities available in the process application tab of the IDE 130 may be managed or executed by the process application tool 310. In one example, the data corresponding to the process applications may be maintained and modified by the process application tool 310. In another example, the process application tool 310 enables creation of the process applications and integration of the process applications with other tools of the IDD platform 150 such as the bot tool 330, digital application tool 350, or data tables tool 370.

By way of example, a bot may be designed and developed in the bot tab in the IDE 130. The bot may be created by dragging and dropping components from a bot component menu into a workspace in the bot application tab of the IDE 130 and connecting the components dropped in the workspace with each other, although bots may be created using other methods. The bot component menu may be displayed upon selecting a user interface button in the workspace. A plurality of bot components may be connected to create a bot task, a digital form, a digital view, a knowledge graph, an alert task, an information task, an action task, or the like. By way of example, digital applications and data tables may be created in the digital applications tab in the IDE 130. The features or functionalities available in the bot tab of the IDE 130 may be managed or executed by the bot tool 330. In one example, the utterances input to the bots may be processed and executed by the bot tool 330. In another example, the data corresponding to the bots may be maintained and modified by the bot tool 330. In another example, the bot tool 330 enables creation of the bots and integration of the bots with other tools of the IDD platform 150.

In one example, a leave request process application may be created in the process application tab using a trigger component, such as a digital form used by the end user to fill leave details, a database connector to retrieve leave balance, a flow component such as split, and a task component such as approval task to request leave approval. These components may be configured and connected to create the leave request workflow application. Once the leave request process application is created and published, an end user such as an employee may fill a form to apply for a leave. When the end user submits the filled form, the leave request process application is triggered and a process instance is created. Subsequently, the employee leave balance is retrieved. The retrieved leave balance along with any other information in the filled form may be presented to an approver for approval in a channel such as a messenger, or email. The approver may approve or reject the leave request and a corresponding notification may be sent to the employee, thus fulfilling the intent of the end user to apply for a leave.

The leave request process application may be simulated in the process application tab before publishing. The user using the simulator may check if the data flow in the application is as expected. Any process instance failure alerts may be displayed, enabling the user to modify the process application before publishing. If the conversational interaction (or auto-create bot tasks) feature is enabled in the process application tab, the IDD platform 150 may auto-create a bot task using a template of a bot task, in an existing bot or as a new bot, enabling employees to check the status of the leave application. In this example, the IDD platform 150 may add the template of the bot task to a Human Resources (HR) bot to enable conversational leave status check.

The process application may also be triggered from a bot using a process node of a bot task. For example, the leave request process application may be triggered from the process node 524 of the get status bot task in the HR bot. Once the process node 524 in the HR bot is configured to trigger the leave request process application, the external permission settings in the leave request process application may be automatically updated to display the HR bot. In examples, the user configuring a process application in the process application tab may enable a bot to trigger the process application. While configuring the process application, the user may add a process input that the process application expects to receive from the bot. Subsequently, when the user configures the bot in the bot tab, the process input configured in the process application may be automatically displayed. The user configuring the bot may assign, for example, the context variable 530 to the process input. The user configuring the process application in the process application tab may provide access to another bot to deliver notifications.

Accordingly, the IDD platform 150 provides users, such as developers, process authors or business analysts by way of example, with many distinct and powerful technological features and advantages. These technological features and advantages include by way of example and amongst others:

(a) auto-creation of dialogs to check status of a process application instance;

(b) define access controls: define the applications, such as bots, digital applications, data tables, or the like, which can access the workflow application and/or the data from the workflow application;

(c) automatically update external permission settings of the process application based on a configuration in the external application;

(d) enable conversational interaction with process applications;

(e) Assign process inputs to process variables in a process application; and

(f) Override notification settings at a task level in the process application.

In this way, the IDD platform 150 can simplify the process of creating process applications and their integration with other enterprise applications such as bots, digital applications, or data tables. The IDD platform 150 also improves automation by providing a unified interface to develop enterprise applications, while eliminating the cumbersome and costly process of integrating process applications with other enterprise applications such as bots.

Interaction with End Users

The IDDP server 112 may enable conversational interaction, non-conversational interaction, or a combination of conversational and non-conversational interaction of end users with process applications (e.g. process application data) using one or more communication modes. The one or more communication modes may comprise chat, voice, digital forms, email, short messaging service (SMS), or a combination of two or more of these, although the one or more communication modes may include other types or numbers of communication modes in other configurations. In one example of conversational interaction, the end user may conversationally interact with the process application using chat, voice, digital forms, email, short messaging service (SMS), or a combination of two or more of these.

Non-conversational interaction may include the IDDP server 112 enabling the end user to interact with the process application using non-conversational methods, such selection one or more options: such as a radio button, from a drop down, from a carousel, from options provided by a voice prompt, or the like, in the one or more communication modes. In one example of non-conversational interaction, the end user may at least partially fill in a static digital form.

The IDDP server 112 may also enable a combination of conversational and non-conversational interaction. In one example, the combination of conversational and non-conversational interaction may include the end user providing a first input having a first user intent to the HR bot in natural language and a second input required by the IDDP server 112 to fulfill the first user intent in a web page, a static digital form, or the like.

The end user may choose to interact with the process application in the one or more communication modes. In one example, the end user may chat with a bot of the bot tool 330 to conversationally interact with the process application. In another example, the end user may voice chat with a bot of the bot tool 330 to conversationally interact with the process application.

Alternatively, the IDDP server 112 may determine one or more communication modes to conversationally interact with the end user based on parameters such as, by way of example, end user preferences, communication mode in which the end user communication is received, content of the conversational interaction, complexity of the conversational interaction, or the like, although the one or more communication mode may be determined based on other parameters in other configurations. The bot tool 330 of the IDDP server 112 may initiate communication with the end user in a determined communication mode, by way of example, when the user intent of an utterance received from the end user corresponds to the process application. The bot tool 330 of the IDDP server 112 may also initiate communication with the end user in a determined communication mode when the IDDP server 112 does not receive the utterance from the end user.

The end user preferences may include a preference of the end user to communicate in the one or more communication modes. The end user preferences may be configured in the IDDP server 112 or determined by the IDDP server 112. In one example, the end user may specify a preferred communication mode as “chat” while conversing with the HR bot. The IDDP server 112 may determine the end user preference based on, for example, communication modes of previous interactions, analyzing content of previous interactions, a fulfillment parameter, or the like. For example, when the end user communicates with the IDDP server 112 ninety eight out of hundred times using voice, the IDDP server 112 may based on the communication mode of previous interactions determine that the end user prefers to communicate using voice. In another example, the IDDP server 112 may analyze content of the previous interactions using natural language processing or machine learning to determine an end user preference. In this example, the end user may have specified a preference in a previous interaction to communicate with the IDDP server 112 using voice. In another example, the IDDP server 112 may, based on analyzing content of a previous interaction, determine a fulfillment parameter such as: Yes/No which indicates if the end user is satisfied with the communication mode. The IDDP server 112 may choose to conversationally interact with the end user in the communication mode based on the fulfillment parameter.

The IDDP server 112 may also determine the one or more communication modes to interact with the end user based on the communication mode in which the IDDP server 112 receives the end user communication. In one example, if the end user conversationally interacts with the HR bot of the IDDP server 112 using chat, the IDDP server may also respond to the end user using chat.

The IDDP server 112 may also determine the one or more communication modes to interact with the end user based on the content of the conversational interaction. The IDDP server 112 may analyze an utterance received from the end user, or content to be output to the end user, using natural language processing, machine learning, or other artificial intelligence techniques and determine one or more communication modes to interact with the end user. In one example, the IDDP server 112 communicating with the end user using voice, may analyze and determine that the content to be output to the end user includes an address, and determines to communicate the address to that end user using chat. The IDDP server 112 provides a notification to the end user over voice that the address will be shared using chat. Subsequently, the IDDP server 112 may send the address to the end user using chat.

The actors may configure communication modes specific to content of the conversational interaction, by way of example, in the IDE 130. In one example, the actor may configure that entity prompts corresponding to a few process variables, process inputs, or form fields may be communicated using voice. The process author may also configure that entity prompts corresponding to a few process variables, process inputs, or form fields may be communicated using chat. The communication mode specific to the entity prompts may be configured, by way of example, in the bot tool 330 of the IDDP server 112.

The IDDP server 112 may also determine the one or more communication modes to interact with the end user based on the complexity of the conversational interaction. The actors may configure communication modes based on complexity of the content, by way of example, in the IDE 130. In one example, the actor may tag that a “reason for leave” entity provided as an input in a digital form-which triggers a leave request process application, includes complex content. The actor may configure in the IDE 130 that the “reason for leave” entity may be prompted using email. In another example, the IDDP server 112 may determine the complexity of the form field in a conversational interaction, by way of example, using historical conversational interaction data and may determine one or more communication modes to interact with the end user based on the determined complexity of the content. It may be understood that entities corresponding to the bot tool 330 may be sent to the process application tool 310 as process inputs, or process variables. Also, the form fields captured in digital forms may be sent to the process application tool 310 as process inputs, or process variables.

For further illustration, the IDDP server 112 may determine complexity of the form fields and based on the complexity of the form fields determine to provide prompts to the end user using one or more communication modes. The complexity of the form fields may be configured by actors, such as process author, process designer, bot developer, or the like. The complexity of the form fields may also be automatically determined by analyzing using: machine learning, natural language processing, and/or artificial intelligence techniques. In one example the complexity of the form fields may be determined, by way of example, by analyzing historical response data to the form fields. By way of example, the IDDP server 112 may compare an average length of the historical response data to the form field to a threshold and determine a communication mode to prompt the end user based on the comparison. In one example, the IDDP server 112 may determine that the average length of the historical response data to the form fields: start date, end date, and leave type does not exceed the threshold and determine to create and output voice prompts for the form fields: start date, end date, and leave type. The IDDP server 112 may also determine that the average length of the historical response data to the form field: reason for the leave request, exceeds the threshold and determine to create and output chat, email, SMS, or digital form based prompts for the form field: reason for the leave request.

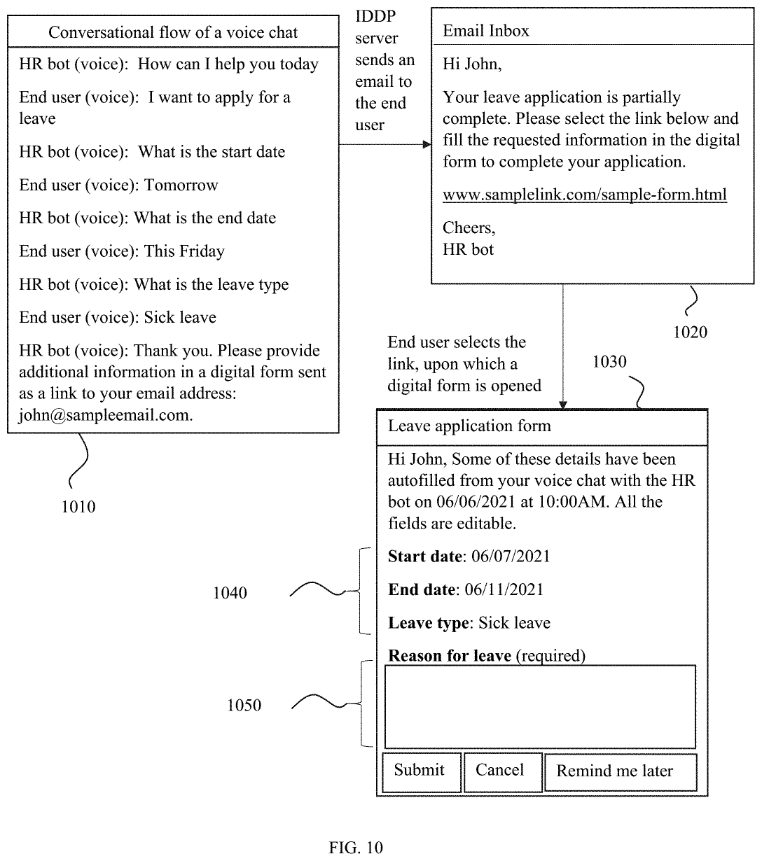

FIG. 10 are a voice chat and screenshots illustrating an example fulfillment of a user intent by the IDDP server 112 using one or more communication modes. A first window 1010 illustrates a conversational flow of a voice chat between the HR bot and the end user. A second window 1020 illustrates an email delivered to an email inbox of the end user. A third window 1030 illustrates a leave application form to be filled by the end user which is opened when the end user selects a uniform resource locator (URL) provided to the end user in the email in the second window 1020. The end user may use the one or more external computing devices 147(1)-147(n) to: perform the voice communication illustrated in the first window 1010, access the email communication illustrated in the second window 1020, or access the leave application form illustrated in the third window 1030.

The IDDP server 112 may orchestrate the voice chat with the end user as illustrated in the first window 1010. A voice input of the end user provided during the voice chat may be converted to text using: a speech-to-text (STT) engine—which is a part of the IDDP server 112, or an external STT engine which converts the voice input to text and sends the text to the IDDP server 112.

The bot tool 330 of the IDDP server 112 receives the text and determines that the user intent of the voice input is to—apply for a leave. The IDDP server 112 may require the entities: start date, end date, leave type, and reason for leave to fulfill the user intent. In this example, the IDDP server 112 may determine based on configuration or a determination that the entity prompts for the entities: start date, end date, and leave type are to be prompted using voice, but the entity prompt for the entity: reason for leave is to be prompted using a digital form.

The IDDP server 112 may determine that the response to be provided to the end user based on the user intent includes the leave application as a digital form. The digital form may include the entities: start date, end date, leave type, and reason for leave as form fields. As the communication mode is voice, the bot tool 330 of the IDDP server 112 outputs textual prompts corresponding to the entities for voice chat, which may be converted into voice prompts using a text-to-speech (TTS) engine which is internal or external to the IDDP server 112.

The IDDP server 112 may convert the entities into prompts based on the one or more communication modes used for the conversational interaction. In one example, when the communication mode is voice, the bot tool 330 of the IDDP server 112 may convert the entities: start date, end date, leave type, reason for leave into textual prompts which are converted into voice prompts by the TTS engine for voice chat. The voice prompts for the entities may be: “what is the start date”, “what is the end date”, “what is the leave type”, and “what is the reason for the leave” respectively. The end user listens to the voice prompts using the one or more external computing devices 147(1)-147(n) and provides voice inputs as illustrated in the first window 1010. Based on the determination that the entity: reason for leave, is to be prompted using a digital form, the IDDP server 112 notifies the end user using voice that an email with the URL of the digital form will be sent to the email address of the end user. Subsequently, the IDDP server 112 sends the email with the URL of the digital form to the email address of the end user. An example email sent to the end user is illustrated in the second window 1020.

The end user selects the URL in the email which redirects the end user to the leave application form with the reason for leave prompt 1050. The other prompts 1040, such as start date, end date, and leave type, may be auto-populated in the leave application form based on the voice inputs provided by the end user. The end user may fill the reason for leave prompt 1050, by way of example, using text and submit the leave application form. Upon submission, the IDDP server 112 may provide a notification to the end user based on subsequent data flow in the process application. An example notification may be: “Your leave application has been submitted. The leave application will now be sent to your HR manager and your program manager.”

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method comprising:
receiving, by an integrated design and development platform (IDDP) server, instructions corresponding to one or more user interactions in a graphical user interface rendered in a user device;
enabling based on the instructions, by the IDDP server,
conversational interaction with a process application by:
cloning one or more bot definitions and adding the cloned one or more bot definitions to an existing bot or a new bot; and
automatically configuring the cloned one or more bot definitions to communicate with the process application.

2. The method of claim 1, wherein the received instructions comprise:
a first instruction corresponding to a first user interaction to enable conversational interaction with the process application;
a second instruction corresponding to a second user interaction selecting one or more bot definitions to the existing bot or the new bot; and
a third instruction corresponding to a third user interaction selecting one or more filter fields as entities to be added to one or more bot definitions.

3. The method of claim 1, further comprising:
receiving, by the IDDP server, a first set of instructions comprising a received utterance as part of a first conversational interaction from an end user device;
determining, by the IDDP server, a user intent of the utterance; and
determining based on the instructions, by the IDDP server, one or more communication modes to orchestrate at least part of the first conversational interaction.

4. The method of claim 1, wherein the instructions comprise an indication of a user interaction to add a first bot definition of the one or more bot definitions to a first bot and a second bot definition of the one or more bot definitions to a second bot.

5. The method of claim 1, wherein the automatic configuration comprises:
adding training information to the cloned one or more bot definitions;
configuring the cloned one or more bot definitions with an application programming interface (API) call to communicate with the process application; and
configuring the cloned one or more bot definitions with entity information.

6. The method of claim 5, wherein the IDDP server configures the API call with an identifier of the process application.

7. The method of claim 5, wherein the entity information is determined based on one or more filter fields received in the instructions.

8. An integrated design and development platform (IDDP) server comprising:
a processor; and
a memory coupled to the processor which is configured to be capable of executing programmed instructions stored in the memory to:
receive instructions corresponding to one or more user interactions performed in a graphical user interface rendered in a user device;
enable, based on the received instructions, conversational interaction with a process application by:
adding a clone of one or more bot definitions to an existing bot or a new bot; and
automatically configuring the cloned one or more bot definitions to interact with the process application.

9. The IDDP server of claim 8, wherein the received instructions comprise:
a first instruction corresponding to a first user interaction to enable conversational interaction with the process application;
a second instruction corresponding to a second user interaction selecting one or more bot definitions to the existing bot or the new bot; and
a third instruction corresponding to a third user interaction selecting one or more filter fields as entities to be added to one or more bot definitions.

10. The IDDP server of claim 8, wherein the processor is further configured to be capable of executing the stored programmed instructions in the memory to:
receive a first set of instructions comprising a received utterance as part of a first conversational interaction from an end user device;
determine a user intent of the utterance; and
determine based on the instructions one or more communication modes to orchestrate at least part of the first conversational interaction.

11. The IDDP server of claim 8, wherein the received instructions comprise an indication of a user interaction to add a first bot definition of the one or more bot definitions to a first bot and a second bot definition of the one or more bot definitions to a second bot.

12. The IDDP server of claim 8, wherein the automatic configuration comprises:
adding training information to the cloned one or more bot definitions;
configuring the cloned one or more bot definitions with an application programming interface (API) call to communicate with the process application; and
configuring the cloned one or more bot definitions with entity information.

13. The IDDP server of claim 12, wherein the IDDP server configures the API call with an identifier of the process application.

14. The IDDP server of claim 12, wherein the entity information is determined based on one or more filter fields received in the instructions.

15. A non-transitory computer-readable medium having stored thereon instructions for enabling and orchestrating enterprise automation which when executed by a processor, causes the processor to:
receive instructions corresponding to one or more user interactions performed in a graphical user interface rendered in a user device;
enable, based on the received instructions, conversational interaction with a process application by:
adding a clone of one or more bot definitions in an existing bot or a new bot; and
automatically configuring the cloned one or more bot definitions to interact with the process application.

16. The non-transitory computer-readable medium of claim 15, wherein the received instructions comprise:
a first instruction corresponding to a first user interaction to enable conversational interaction with the process application;
a second instruction corresponding to a second user interaction selecting one or more bot definitions to the existing bot or the new bot; and
a third instruction corresponding to a third user interaction selecting one or more filter fields as entities to be added to one or more bot definitions.

17. The non-transitory computer-readable medium of claim 15, wherein the executable instructions when executed by the processor further causes processor to:
receive a first set of instructions comprising a received utterance as part of a first conversational interaction from an end user device;
determine a user intent of the utterance; and
determine based on the instructions one or more communication modes to orchestrate at least part of the first conversational interaction.

18. The non-transitory computer-readable medium of claim 15, wherein the received instructions comprise an indication of a user interaction to add a first bot definition of the one or more bot definitions to a first bot and a second bot definition of the one or more bot definitions to a second bot.

19. The non-transitory computer-readable medium of claim 15, wherein the automatic configuration comprises:
adding training information to the cloned one or more bot definitions;
configuring the cloned one or more bot definitions with an application programming interface (API) call to communicate with the process application; and
configuring the cloned one or more bot definitions with entity information.

20. The non-transitory computer-readable medium of claim 19, wherein the instructions which when executed by the processor, further cause the processor to configure the API call with an identifier of the process application.

21. The non-transitory computer-readable medium of claim 19, wherein the entity information is determined based on one or more filter fields received in the instructions.
